(19) United States
(12) Patent Application Publication
(10) Pub. No.: US 2023/0315859 A1
(43) Pub. Date: Oct. 5, 2023

(54) COMPUTER DEVICE INCLUDING DIVIDED SECURITY MODULE AND METHOD FOR UPDATING SECURITY MODULE

(71) Applicant: SECUVE CO., LTD., Seoul (KR)

(72) Inventor: Ki-Yoong HONG, Seoul (KR)

(73) Assignee: SECUVE CO., LTD., Seoul (KR)

(21) Appl. No.: 17/269,922

(22) PCT Filed: Dec. 30, 2020
(86) PCT No.: PCT/KR2020/019418

§ 371 Date: Jun. 20, 2023

(30) Foreign Application Priority Data
Nov. 17, 2020 (KR) 10-2020-0153534

(51) Int. Cl. G06F 21/57; G06F 8/65

(52) U.S. Cl. CPC G06F 21/572; G06F 8/65; G06F 2221/034

(57) ABSTRACT

Provided are a computer device including a separated security module, and a method for updating the security module. The computer device may include an OS kernel and a separated security module. The OS kernel is installed at a kernel level to operate, and has a security callback function. The separated security module is installed at the kernel level to operate, and is divided into a non-updatable part and an updatable part. Furthermore, the separated security module includes: the non-updatable part configured to directly interface with the OS kernel and to be connected to the security callback function; the updatable part configured to indirectly interface with the OS kernel through the non-updatable part; and an update manager configured to control update on the updatable part.

### TECHNICAL FIELD

The present disclosure relates to a security module of a computer device, and a method for updating the security module.

### BACKGROUND ART

Malware is a generic term for all types of malicious software that may adversely affect computer devices. Known types of malware include computer viruses, worms, trojan horses, spyware, adware, rootkits, ransomware, etc.

Some of security modules designed to deal with malware threats are installed at a kernel level of a computer device and interface with an operating system (OS) kernel, and are thus fundamentally responsible for the security of hardware and processes of the computer device. A security module installed at a kernel level is written in code that enables hooking into an OS kernel to monitor activities of a computer device.

However, once such a security module is installed in a computer device, it may be difficult to update the security module in some OS environments. That is, upgrading to other code to update a security function of the security module may require modification of an OS kernel itself, such as recompiling the OS kernel. As a result, a developer or supplier of the security module may be unable to update the security module quickly and may have to wait until the next upgrade on the OS kernel itself.

In this way, since it is difficult to update a security module in some types of OSs, computer devices can be easily vulnerable to malicious attacks. This inflexibility is undesirable in today's rapidly changing cybersecurity environment. One of the factors that can effectively cope with malware attacks is rapidity and flexibility to update functions of a security module quickly and easily at the rate exceeding the rate of change in a malware attack strategy.

### DISCLOSURE

### Technical Problem

One of the objectives of the present disclosure is to enable a security module installed at a kernel level to be updated quickly and easily.

Another objective of the present disclosure is to strengthen a security function of a computer device including a security module installed at a kernel level.

### Technical Solution

The present disclosure provides a computer device including a separated security module, and a method for updating the security module.

According to an embodiment of the present disclosure, the computer device may include an OS kernel and a separated security module. The OS kernel may be installed at a kernel level to operate, and may have a security callback function. The separated security module may be installed at the kernel level to operate, and may be divided into a non-updatable part and an updatable part. Furthermore, the separated security module may include: the non-updatable part configured to directly interface with the OS kernel and to be connected to the security callback function; the updatable part configured to indirectly interface with the OS kernel through the non-updatable part; and an update manager configured to control update on the updatable part.

According to an embodiment of the present disclosure, the security callback function of the OS kernel may be called in response to a particular activity of the computer device, may be to transmit a query to the updatable part through the non-updatable part, and may be to receive a response to the query from the updatable part through the non-updatable part.

According to an embodiment of the present disclosure, the non-updatable part of the security module may be configured to hook the security callback function to have code in which the security callback function of the OS kernel refers to the non-updatable part.

According to an embodiment of the present disclosure, the computer device may further include security software installed at a user level to operate, and the updatable part may be configured to interface with the security software.

According to an embodiment of the present disclosure, the OS kernel may further have a security function of providing an access control security policy at the kernel level, and either the non-updatable part or the updatable part or both may be configured to interact with the security function of the OS kernel.

According to an embodiment of the present disclosure, a method for updating a security module of a computer device is a method for updating a security module of a computer device including: an OS kernel installed at a kernel level to operate; and a separated security module installed at the kernel level to operate. The separated security module may include: a non-updatable part configured to directly interface with the OS kernel; an updatable part configured to indirectly interface with the OS kernel through the non-updatable part; and an update manager configured to control update on the updatable part. The method may include: installing the separated security module at the kernel level in step S1; receiving a request for updating the separated security module in step S2; verifying an update requesting object that has transmitted the request for updating in step S3; receiving a security module update version corresponding to the updatable part of the separated security module in step S4; verifying the received security module update version in step S5; and installing the security module update version in step S6.

According to an embodiment of the present disclosure, in the step S2, (a) the request for updating may be received from a user who has directly accessed the computer device, (b) the request for updating may be received through a server from a user who has accessed the server connected to the computer device over an internal communication network, (c) the request for updating may be received through a terminal or a server and through a network from a user who has accessed the terminal or the server connected to the computer device over the network, or (d) the request for updating may be received through a user terminal and a cloud from a user who has accessed the cloud connected to the computer device over the network.

According to an embodiment of the present disclosure, in the step S3, at least one selected from a group of user authentication, server authentication, network authentication, and terminal authentication may be performed.

### Advantageous Effects

According to the present disclosure, the security module installed as the kernel level of the computer device is realized as a separated security module divided into the non-updatable part and the updatable part, and the non-updatable part directly interfaces with the OS kernel and the updatable part indirectly interfaces with the OS kernel through the non-updatable part, so that only the updatable part of the security module can be updated independently of the OS kernel. According to the present disclosure, the security module installed at the kernel level can be updated quickly and easily.

In addition, according to the present disclosure, the security module can be updated by changing or modifying only code of the updatable part without changing the non-updatable part directly connected to the OS kernel, so that the security module can be updated without recompiling the OS kernel. According to the present disclosure, the computer device can be immediately updated without rebooting.

In addition, according to the present disclosure, when a request for updating the security module is received, an update requesting object is verified, and when a security module update version is received, the received security module update version is verified, so that security can be further strengthened through two-factor verification of the update requesting object and the update version.

### DESCRIPTION OF DRAWINGS

FIG. 1 is a diagram illustrating various use environments of a computer device according to an embodiment of the present disclosure.

FIG. 2 is a diagram illustrating a configuration related to an OS kernel and a security module of a computer device according to an embodiment of the present disclosure.

FIG. 3 is a diagram illustrating a method for updating a security module of a computer device according to an embodiment of the present disclosure.

### BEST MODS

Hereinafter, embodiments of the present disclosure will be described in detail with reference to the accompanying drawings.

The present disclosure may be embodied in various forms, and should not be construed as being limited to the embodiments described herein. The described embodiments are provided to sufficiently convey the scope of the present disclosure to those skilled in the art to which the present disclosure pertains. The principles and features of the present disclosure may be applied in a wide variety of embodiments without departing from the scope of the present disclosure.

In addition, in describing the embodiments, matters well known in the art to which the present disclosure pertains or not directly related to the present disclosure will not be described in order to clearly convey the essence of the present disclosure without obscurity. In the attached drawings, some elements may be exaggerated, omitted, or roughly illustrated, and the size of each element does not exactly correspond to an actual size of each element. Like reference numerals are given to the same or corresponding elements throughout the accompanying drawings.

Unless defined otherwise, all terms used herein, including technical and scientific terms, have the same meaning as understood by those skilled in the art to which the present disclosure pertains. In the meantime, although the singular forms are stated, the plural forms are included, unless the context clearly indicates otherwise.

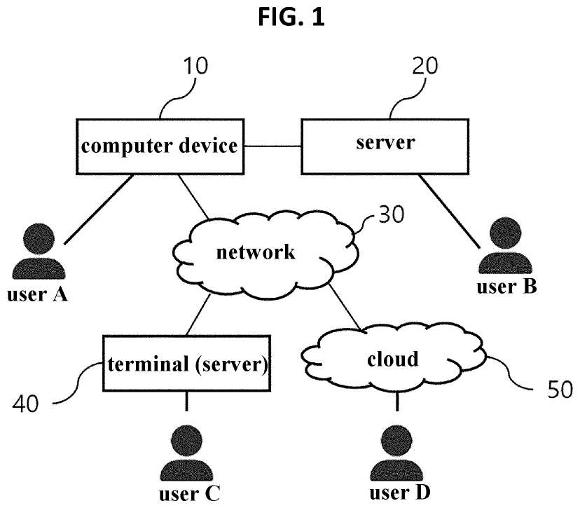

FIG. 1 is a diagram illustrating various use environments of a computer device according to an embodiment of the present disclosure.

Referring to FIG. 1, a computer device 10 according to an embodiment of the present disclosure may be used in various environments. For example, user A may use the computer device 10 by directly accessing the computer device 10. As another example, user B may use the computer device 10 by accessing a server 20 connected to the computer device 10 over an internal communication network. As still another example, user C may use the computer device 10 by accessing a terminal 40 (or server) connected to the computer device 10 over a network 30, such as the Internet. As still another example, user D may use the computer device 10 by accessing a cloud 50 with a user terminal (not shown), wherein the cloud is connected to the computer device 10 over the network 30.

The computer device 10 is a computer device including an OS kernel and a separated security module, which will be described below, of the present disclosure, and there is no particular limitation on the type of the computer device. The terminal 40 is a term including a portable user electronic device. In some embodiments, the terminal 40 may be a server. Using the computer device 10 by a user include updating the security module included in the computer device 10 to a new version.

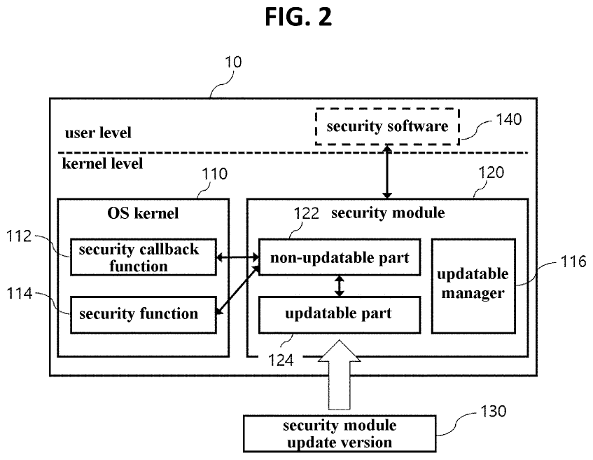

FIG. 2 is a diagram illustrating a configuration related to an OS kernel and a security module of a computer device according to an embodiment of the present disclosure.

Referring to FIG. 2, a computer device 10 according to an embodiment of the present disclosure includes an OS kernel 110 and a security module 120 that are installed at a kernel level to operate. FIG. 2 shows the computer device 10, focusing on the OS kernel 110 and the security module 120 directly related to the present disclosure, but other various known components (for example, a processor, a memory, an input/output device, a communication module, etc.) may be included in the computer device 10.

The OS kernel 110 has a security callback function 112 and a security function 114, and the security module 120 includes a non-updatable part 122, an updatable part 124, and an update manager 126. The OS kernel 110 means a kernel of any OS type, and examples of the OS include all commercial OSs, such as Unix, Linux, Mac, Windows, etc. In that the security module 120 is divided into the non-updatable part 122 and the updatable part 124, the security module 120 of the present disclosure may be referred to as a ‘separated security module’.

The non-updatable part 122 of the security module 120 may directly interface with the OS kernel 110 and may be connected to the security callback function 112 of the OS kernel 110. In contrast, the updatable part 124 of the security module 120 indirectly interfaces with the OS kernel 110 through the non-updatable part 122. In the specification, the meaning of interfacing does not refer to a physical interface, but means interacting through data transmission and reception.

The non-updatable part 122 is not updatable in that code of the non-updatable part 122 is unable to be easily changed or modified without complicated procedures for modifying code and recompiling the OS kernel 110 itself.

Compared to the non-updatable part 122, the updatable part 124 is updatable in that code change or modification is easy. That is, the updatable part 124 may be easily changed or modified without recompiling the OS kernel 110. In addition, the updatable part 124 is immediately updatable without rebooting the computer device 10.

When the security module 120 is installed in the computer device 10, the non-updatable part 122 directly interfaces with the OS kernel 110 and the updatable part 124 indirectly interfaces with the OS kernel 110 through the non-updatable part 122. Accordingly, the separated security module 120 provides appropriate separation between the updatable part 124 and the OS kernel 110. This allows a developer or supplier of the security module 120 to update the security module 120 independently of the OS kernel 110. That is, the developer or supplier of the security module 120 may update the security module 120 by changing or modifying only code of the updatable part 124 without changing the non-updatable part 122 directly connected to the OS kernel 110.

The security callback function 112 of the OS kernel 110 may be called in response to a particular activity of the computer device 10, such as file opening, network connection opening, or application running.

In a case in which the security module 120 does not exist, the security callback function 112 of the OS kernel 110 refers to a particular security function 114 of the OS kernel 110. The security function 114 provides an access control security policy at the kernel level.

In the case in which the security module 120 does not exist, when the security callback function 112 is called (in response to file opening, for example), the security callback function 112 makes a query to the security function 114 to request authority to open a file and the security function 114 returns a response to the query. The response indicates whether the process (for example, file opening and running) is allowed. In the case in which the security module 120 does not exist, this security mechanism of the OS kernel 110 is fixed, so a malicious attacker can easily judge how the security function works in the OS kernel 110 and can easily determine how to defeat the security mechanism. That is, since the fixed security mechanism cannot be easily changed, an attacker has enough time to develop an attack strategy to circumvent the security mechanism of the OS kernel 110. Accordingly, dynamically updating the security module 120, specifically, the updatable part 124 of the security module 120, may make it difficult for an attacker to defeat or circumvent the security mechanism.

In the meantime, in the case in which the security module 120 of the present disclosure is implemented, the non-updatable part 122 of the security module 120 may be configured to hook the security callback function 112 of the OS kernel 110. This hooking means that at the OS kernel 110, the code in which the security callback function 112 refers to the security function 114 is replaced with another code in which the security callback function 112 refers to the non-updatable part 122 of the security module 120 instead of the security function 114. Accordingly, when the security callback function 112 is called, the security callback function 112 may transmit a query to the non-updatable part 122 and the non-updatable part 122 may forward the query to the updatable part 124. This provides the security module 120 with an ability to monitor events and/or related data of the computer device 10.

The updatable part 124 that has received a query generates and returns a response indicating whether execution of a process is allowed. That is, the updatable part 124 may determine the characteristics of a query (for example, a type of callback), may search for a parameter related to the determination, may analyze an event and/or data related to the query, and may judge whether the analyzed event and/or data is associated with malicious code. On the basis of the judgement, the updatable part 124 may generate a response to a query and may provide the response to the OS kernel 110 through the non-updatable part 122. For example, when a query is related to a request for opening a particular file, the updatable part 124 may determine that the request for opening the particular file is associated with malicious code, may generate a response indicating suspension of execution of a process for opening the particular file, and may return the response to the OS kernel 110.

In the meantime, in some embodiments, the updatable part 124 that has received a query from the OS kernel 110 through the non-updatable part 122 may interface with the security software 140 that is installed at the user level of the computer device 10 and is in operation and may request analysis of an event and/or data related to the query, and determination of whether there is association with malicious code.

In addition, in some embodiments, the non-updatable part 122 and/or the updatable part 124 may interact with the security function 114 of the OS kernel 110. This interaction with the security function 114 may occur after the non-updatable part 122 receives a query from the security callback function 112. For example, the non-updatable part 122 may directly make a query to the security function 114 about the access control security policy of the OS kernel 110. As another example, the updatable part 124 may indirectly make a query to the security function 114 through the non-updatable part 122. The security policy may be considered when the updatable part 124 generates a response to a query.

The non-updatable part 122 may be installed to occupy a minimum memory capacity and may be executed to consume minimum resources. That is, the non-updatable part 122 consists of much less code than the updatable part 124, and most of the functions of the security module 120 may be provided by the code of the updatable part 124. The non-updatable part 122 serves as a passage for primarily providing separation between the OS kernel 110 and the updatable part 124 and only forwarding a query/response between the OS kernel 110 and the updatable part 124.

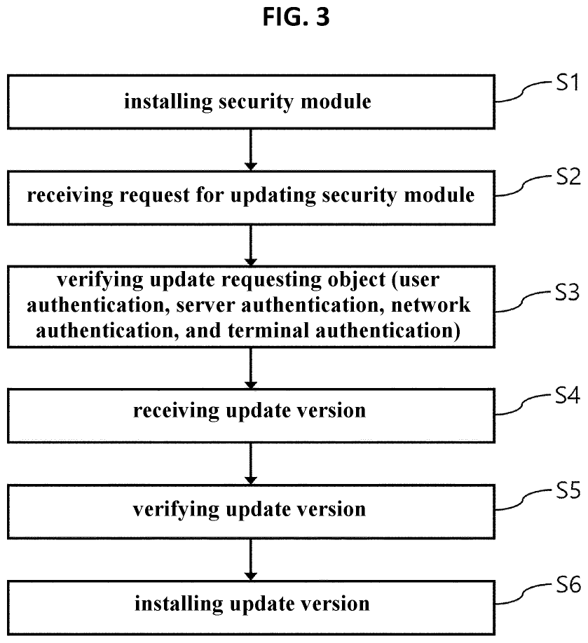

In the meantime, when the update manager 126 of the security module 120 receives a request for update on the security module 120, the update manager 126 may verify an update requesting object, and when a security module update version 130 is received, the update manager 126 may verify the received security module update version 130. In this way, security may be further strengthened through two-factor verification of the update requesting object and the update version. A detailed description of this will be described below with reference to FIG. 3.

FIG. 3 is a diagram illustrating a method for updating a security module of a computer device according to an embodiment of the present disclosure. The following description will be made with reference to FIGS. 1 to 3.

First, in step S1, a computer device 10 installs a separated security module 120 as shown in FIG. 2 at a kernel level. The computer device 10 includes an OS kernel 110 that is installed at the kernel level to operate. The OS kernel 110 includes a security callback function 112. The separated security module 120 installed in step S1 operates at the kernel level, and includes a non-updatable part 122, an updatable part 124, and an update manager 126. The non-updatable part 122 directly interfaces with the OS kernel 110 and is connected to the security callback function 112. The updatable part 124 indirectly interfaces with the OS kernel 110 through the non-updatable part 122. The update manager 126 controls update on the updatable part 124. In particular, the non-updatable part 122 of the security module 120 is configured to hook the security callback function 112 to have code in which the security callback function 112 of the OS kernel 110 refers to the non-updatable part 122.

Next, in step S2, the computer device 10 receives a request for updating the security module 120 from a user. For example, in various environments as shown in FIG. 1, the computer device 10 may receive a request for update. Specifically, the computer device 10 may receive an request for update through an input device from user A, who has directly accessed the computer device 10, or may receive a request for update through a server 20 from user B, who has accessed the server 20 connected to the computer device 10 over an internal communication network, or may receive a request for update through a terminal 40 (or server) and a network 30 from user C, who has accessed the terminal 40 (or server) connected to the computer device 10 over the network 30, or may receive a request for update through a user terminal (not shown) and a cloud 50 from user D, who has accessed the cloud 50 connected to the computer device 10 over the network 30.

Next, in step S3, the computer device 10 verifies an update requesting object. In the specification, the update requesting object refers to a subject or medium, specifically, a user, a server, a network, or a terminal, which sends a request for updating the security module 120 to the computer device 10. Accordingly, in step S3, the update requesting object is determined according to the situation in which the request for update is received in step S2, and verification is performed. The verification may include user authentication, server authentication, network authentication, or terminal authentication.

User authentication is to authenticate whether user A is a legitimate user having an update request authority when the computer device 10 receives a request for update directly from user A. To this end, various known user authentication methods may be applied.

Server authentication is to authenticate whether the server 20 is a server permitted to access or whether the server 20 is a server to which update request authority is granted when the computer device 10 receive a request for update from user B through the server 20. To this end, various known server authentication methods may be applied. In addition, user authentication may be performed concurrently with server authentication.

Network authentication is to authenticate whether the network 30 is a trustworthy network or whether the network 30 is a network permitted to access when the computer device 10 receives a request for update from user C through the network 30 and the terminal 40 (or server) or receives a request for update from user D through the network 30 and the cloud 50. To this end, various known network authentication methods may be applied. In addition, user authentication may be performed concurrently with network authentication.

Terminal authentication is to authenticate whether the terminal 40 (or server) or the user terminal (not shown) is a terminal permitted to access or whether the terminal 40 (or server) or the user terminal (not shown) is a terminal to which update request authority is granted when the computer device 10 receives a request for update from user C through the network 30 and the terminal 40 (or server) or receives a request for update from user D through the cloud 50 and the user terminal (not shown). To this end, various known terminal authentication methods may be applied. In addition, user authentication and/or network authentication may be performed concurrently with terminal authentication.

Next, when the verifying of the update requesting object in step S3 succeeds, the computer device 10 receives a security module update version 130 in step S4. The security module update version 130 corresponds to the updatable part 124 of the security module 120 installed in the computer device 10. Herein, the security module update version 130 may be provided being stored in a storage medium or may be downloaded from an update providing server.

Next, in step S5, the computer device 10 verifies the received security module update version 130. The verifying of the security module update version 130 is to detect malicious software (malware) in the security module update version 130 corresponding to the updatable part 124 of the security module 120. To this end, various known malware diagnosis methods may be applied.

Next, in step S6, the computer device 10 installs the security module update version 130 that has passed verification. That is, the computer device 100 replaces the updatable part 124 of the security module 120 installed at the kernel level with the security module update version 130 to complete the update on the security module 120.

In the meantime, at least some steps among steps S2 to S6 described above may be performed by the update manager 126 of the security module 120.

The embodiments of the present disclosure disclosed in the specification and drawings are only presented as particular examples to easily describe the technical details of the present disclosure and to help understanding of the present disclosure, and are not intended to limit the scope of the present disclosure. It is clear to a person skilled in the art to which the present disclosure pertains that other modified examples based on the technical idea of the present disclosure can be implemented.

### DESCRIPTION OF THE REFERENCE NUMERALS IN THE DRAWINGS

10: computer device
20: server
30: network
40: terminal
110: OS kernel
112: security callback function
114: security function
120: security module
122: non-updatable part
124: updatable part
126: update manager
130: security module update version
140: security software

1. A computer device, comprising:
an OS kernel installed at a kernel level to operate, and having a security callback function; and
a separated security module installed at the kernel level to operate, and divided into a non-updatable part and an updatable part,
wherein the separated security module comprises
the non-updatable part configured to directly interface with the OS kernel and to be connected to the security callback function,
the updatable part configured to indirectly interface with the OS kernel through the non-updatable part, and
an update manager configured to control update on the updatable part.

2. The computer device of claim 1, wherein the security callback function of the OS kernel is called in response to a particular activity of the computer device, is to transmit a query to the updatable part through the non-updatable part, and is to receive a response to the query from the updatable part through the non-updatable part.

3. The computer device of claim 1, wherein the non-updatable part of the security module is configured to hook the security callback function to have code in which the security callback function of the OS kernel refers to the non-updatable part.

4. The computer device of claim 1, further comprising
security software installed at a user level to operate;
wherein the updatable part is configured to interface with the security software.

5. The computer device of claim 1, wherein the OS kernel further has a security function of providing an access control security policy at the kernel level, and
either the non-updatable part or the updatable part or both are configured to interact with the security function of the OS kernel.

6. A method for updating a security module of a computer device including: an OS kernel installed at a kernel level to operate; and a separated security module installed at the kernel level to operate,
wherein the separated security module includes: a non-updatable part configured to directly interface with the OS kernel; an updatable part configured to indirectly interface with the OS kernel through the non-updatable part; and an update manager configured to control update on the updatable part,
the method comprising:
installing the separated security module at the kernel level in step S1;
receiving a request for updating the separated security module in step S2;
verifying an update requesting object that has transmitted the request for updating in step S3;
receiving a security module update version corresponding to the updatable part of the separated security module in step S4;
verifying the received security module update version in step S5; and
installing the security module update version in step S6.

7. The method of claim 6, wherein in the step S2,
(a) the request for updating is received from a user who has directly accessed the computer device,
(b) the request for updating is received through a server from a user who has accessed the server connected to the computer device over an internal communication network,
(c) the request for updating is received through a terminal or a server and through a network from a user who has accessed the terminal or the server connected to the computer device over the network, or
(d) the request for updating is received through a user terminal and a cloud from a user who has accessed the cloud connected to the computer device over the network.

8. The method of claim 7, wherein in the step S3, at least one selected from a group of user authentication, server authentication, network authentication, and terminal authentication is performed.
